(19) United States
(12) Patent Application Publication
(10) Pub. No.: US 2011/0210298 A1
(43) Pub. Date: Sep. 1, 2011

(54) Post lift for vehicles

(75) Inventor: Maurizio BONACINI, Correggio (RE) (IT)

(73) Assignee: GIULIANO Group S.p.A., Correggio (RE) (IT)

(21) Appl. No.: 12/932,433

(22) Filed: Feb. 25, 2011

(30) Foreign Application Priority Data
Feb. 26, 2010 (IT) MO2010A000045

(51) Int. Cl. B66F 7/16

(52) U.S. Cl. 254/89 H

(57) ABSTRACT

The post lift (1) for vehicles comprises: at least one supporting post (2); at least one sustaining element (4) associated with the post (2), sliding along a substantially vertical direction and positionable in contact with a portion of a vehicle to be lifted; at least a fluid operating actuator device (7) associated with the sustaining element (4); at least a pumping device (8) associated with the actuator device (7) through a first closed circuit (9) and suitable for pumping a first fluid towards the actuator device (7) to move the sustaining element (4) from a lowered position to a raised position; an exhaust valve (10) associated with the first circuit (9) and which can be operated to allow the first fluid to flow from the actuator device (7) to move the sustaining element (4) from the raised position to the lowered position; a second closed circuit (21) associated with the exhaust valve (10) and a manual device (22) for varying the pressure of a second fluid inside the second circuit (21) between a minimum pressure value, in which the exhaust valve (10) is closed, and a maximum pressure value, in which the exhaust valve (10) is open.

The present invention relates to a post lift for vehicles.

As is known, so-called “lifting” devices are commonly used inside motor vehicle garages/workshops to lift vehicles, for the purpose of allowing access to the lower parts of the vehicles themselves by operators for normal maintenance or repair jobs.

A particular and widely used type of such devices is that of “post lifts”.

The post lifts generally used comprise:
a pair of supporting posts extending vertically parallel and distanced from one another;
on each of the posts, a vertically sliding trolley suitable for sustaining one or more horizontal telescopic arms, having at their free extremities pads positionable in contact with respective lower portions of a vehicle to be lifted;
operation means for operating the lifting and lowering movement of the trolleys.

It is also known that conventional international safety regulations require the presence on the post lifts of devices for retaining the arms during the stop phase, suitable for engaging so as to prevent the accidental lowering of the arms due, e.g., to an operating means fault.

The retention devices are generally composed of specific pawls integrally associated with the trolley which, in normal conditions, are fastened inside respective seats obtained along the supporting posts.

In particular, the removal of such pawls from the respective seats can be done manually by an operator before the arms drop down or, alternatively, can be controlled automatically following operation of the drop control of the arm supporting trolleys.

The known post lifts, in particular, can be of the electro-mechanical type.

In this case, the arm up/down operating means are composed of electro-mechanical actuators comprising, e.g., a worm screw, housed inside the posts and operatively associated with the arm supporting trolleys.

The electro-mechanical actuators are suitably connected to an external electric power line and controlled by means of an electric control unit.

The post lifts of the electro-mechanical type do however have a number of drawbacks.

In fact, the movement of the arms, any automation of the retention devices and, in general, compliance with all the necessary safety precautions, requires the use, the coordination and the maintenance of numerous actuators and electronic sensors.

This inevitably leads to the use of complex control electronics, and consequently increases the total cost of lift manufacture.

Alternatively, the use is known of electro-hydraulic type post lifts.

In this case, the operating means comprise a pair of hydraulic cylinders housed inside the supporting posts and operatively associated with the arm supporting trolleys.

A motor/pump assembly is connected to each hydraulic cylinder by means of a suitable hydraulic circuit and can be operated by means of power controls for lifting the arms.

The lowering of the arms is by means of the opening of a hydraulic circuit exhaust valve, controlled pneumatically or electronically.

The release of the pawls to allow the arms to drop can be controlled manually, pneumatically or electrically.

In the first case however, the presence of a manual mechanism does not allow complying with the normally required international safety requirements.

In the case of pneumatic operation, on the other hand, an external pneumatic supply line is used, connected to the exhaust valve and to pneumatic cylinders that move the pawls.

The introduction of air under pressure by means of the external pneumatic supply line, controlled by means of specific controls, thus allows opening the exhaust valve and operating the pneumatic cylinders to release the pawls.

The electro-hydraulic post lifts of known type are also not without drawbacks however.

In particular, the lowering of the arms requires the use of supplementary electronic devices or, alternatively, the use of an external pneumatic supply line.

In the first case, this inevitably calls for the use of complex control electronics and, therefore, results in an increase in the total cost of lift manufacture.

In the second case, on the other hand, the lift user is forced to equip the workstation with an external pneumatic supply line which, besides increasing the total costs for the user itself; is not always easy to do.

The main aim of the present invention is to provide a post lift for vehicles which allows the lifting and lowering of vehicles within the ambit of a solution that is easy to achieve, easy and effective to use and inexpensive.

Another object of the present invention is to provide a post lift for vehicles that complies with the safety requirements needed to safeguard the operators.

The above objects are achieved by the present post lift for vehicles, comprising:
at least one supporting post;
at least one sustaining element associated with said post, sliding along a substantially vertical direction and positionable in contact with at least a portion of a vehicle to be lifted;
at least a fluid operating actuator device associated with said sustaining element;
at least a pumping device associated with said actuator device through a first closed circuit and suitable for pumping a first fluid towards said actuator device to move said sustaining element from a lowered position to a raised position;
at least an exhaust valve associated with said first circuit and which can be operated to allow said first fluid to flow from said actuator device to move said sustaining element from said raised position to said lowered position;
at least a second closed circuit associated with said exhaust valve; and
at least a manual device for varying the pressure of a second fluid inside said second circuit between a minimum pressure value, in which said exhaust valve is closed, and a maximum pressure value, in which said exhaust valve is open.

Other characteristics and advantages of the present invention will become more evident from the description of a preferred, but not sole, embodiment of a post lift for vehicles, illustrated purely as an example but not limited to the annexed drawings in which:

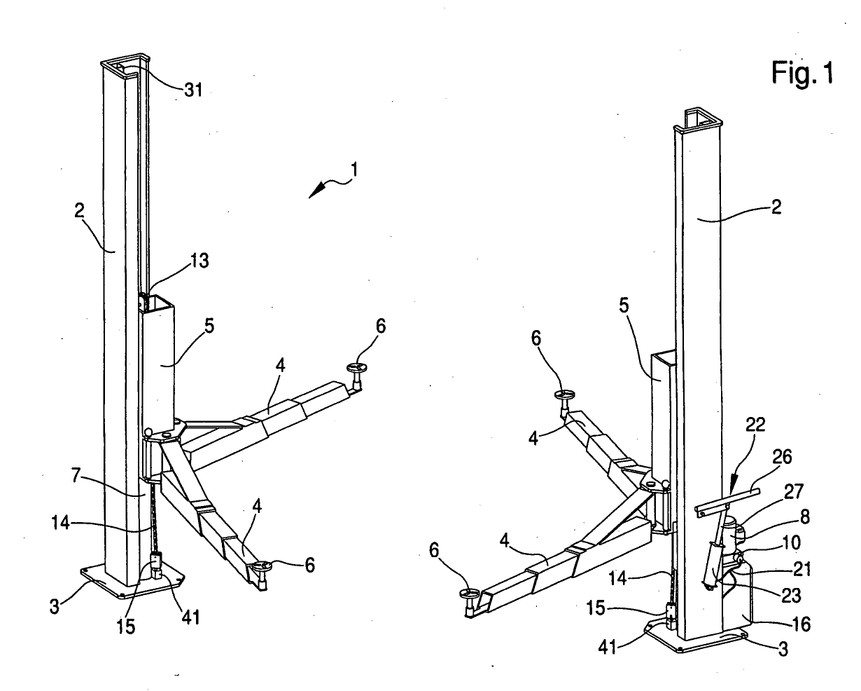

FIG. 1 is an axonometric view of the lift according to the invention;

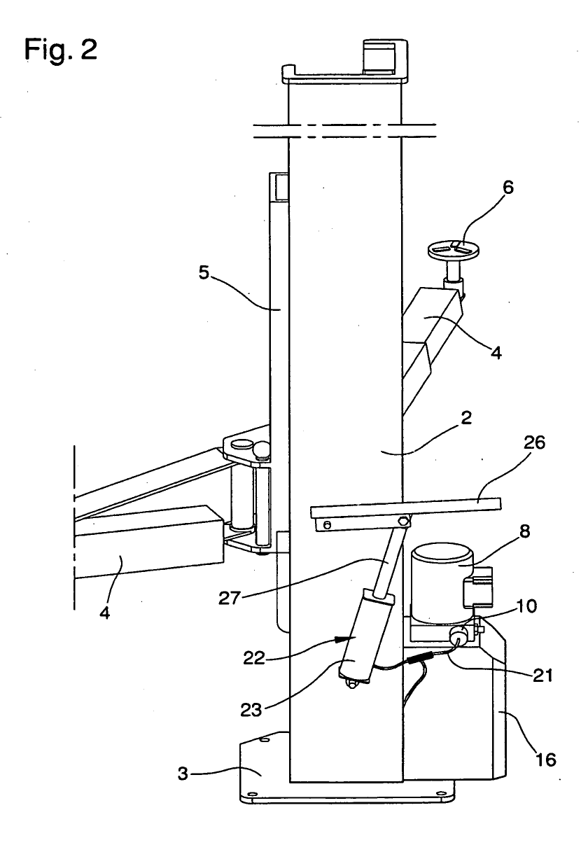

FIG. 2 is an axonometric side view of one of the posts of the lift according to the invention;

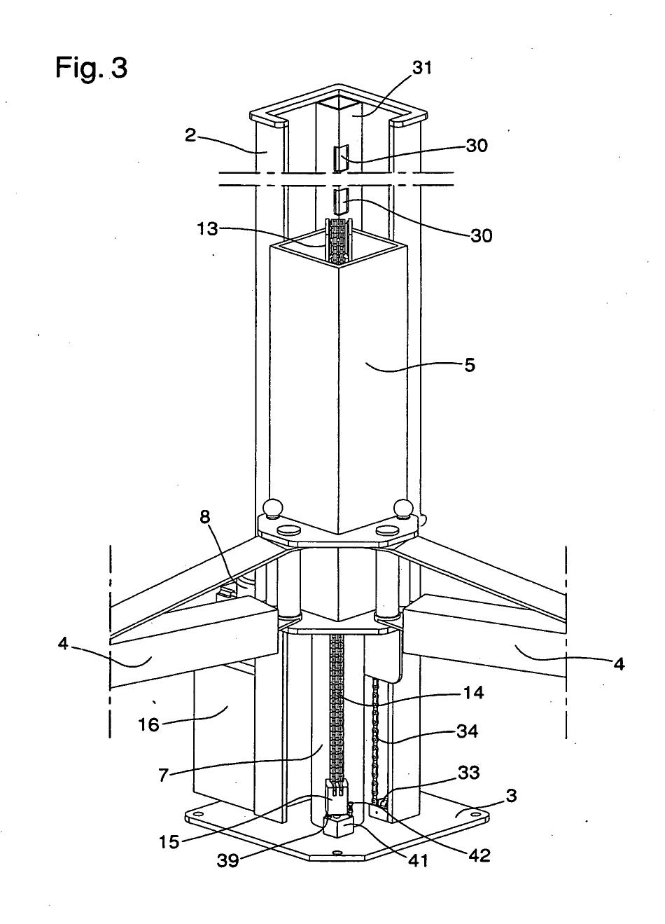

FIG. 3 is an axonometric front view of one of the posts of the lift according to the invention;

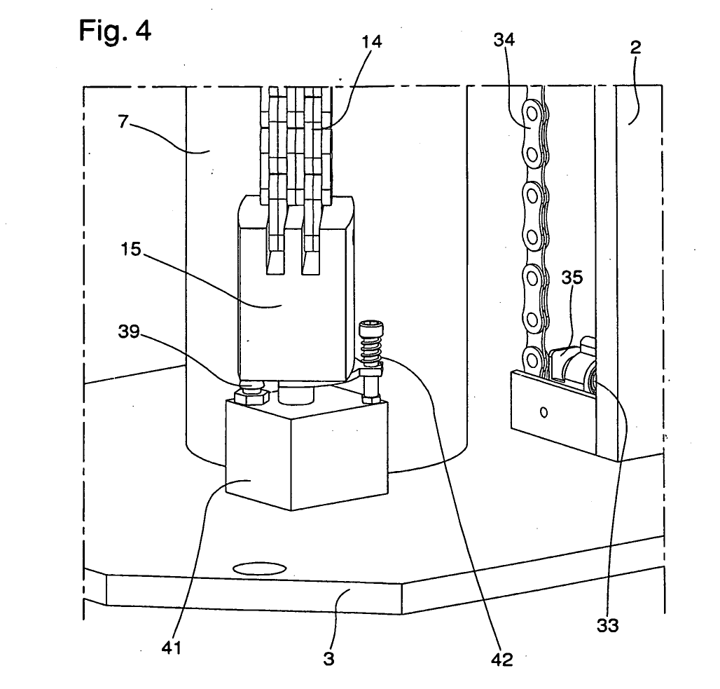

FIG. 4 is a view of a detail of one of the posts of the lift according to the invention;

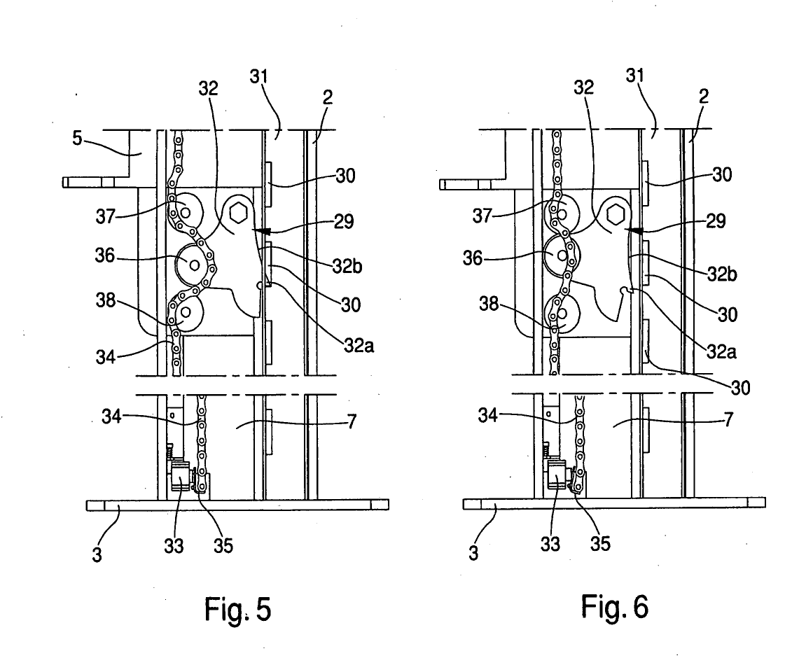

FIGS. 5 and 6 are side views in section that show the retention means of the lift according to the invention in the stop configuration and in the release configuration, respectively;

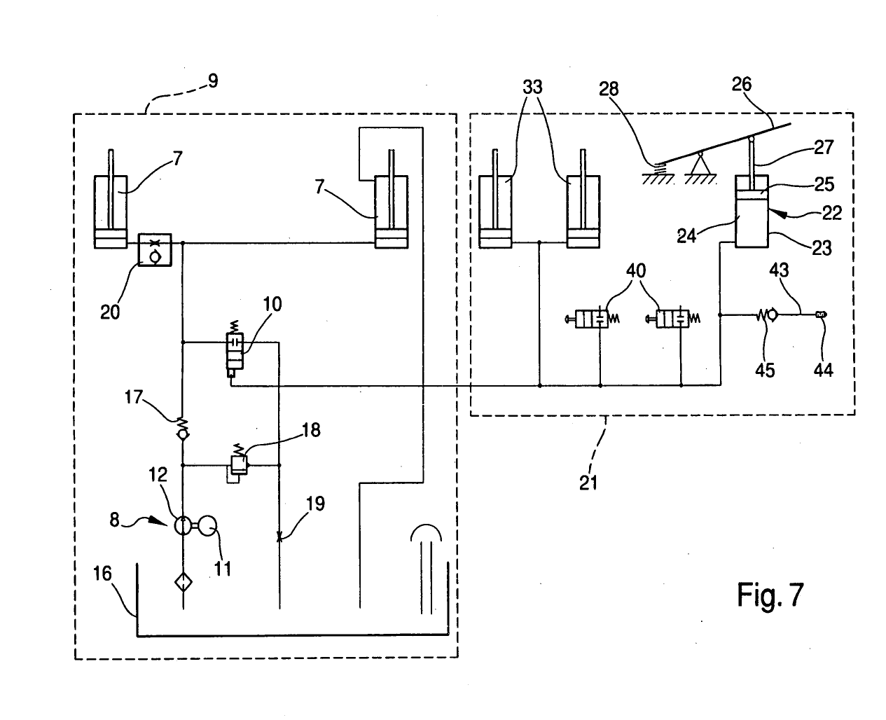

FIG. 7 schematically shows the first and second circuit of the lift according to the invention.

With particular reference to such figures, globally indicated by 1 is a post lift, of the type commonly used inside motor vehicle garages/workshops to lift vehicles, for the purpose of allowing access to the lower parts of the vehicles themselves by operators for normal maintenance or repair jobs.

The lift 1 comprises:
a pair of supporting posts 2, each of which having a base 3 that can be fastened to the ground;
two sustaining elements 4, associated with respective posts 2, sliding along a substantially vertical direction and positionable in contact with respective portions of a vehicle to be lifted.

In particular, with reference not only to the embodiment of the lift 1 shown in the illustrations, on each post 2 is fitted, sliding vertically, a trolley 5 suitable for supporting a pair of sustaining elements 4.

Each sustaining element 4 is composed of a horizontal telescopic arm, of adjustable length, with one extremity hinged to the trolley 5 around a vertical rotation axis and with the opposite extremity having a rubber pad 6 positionable in correspondence to a predefined area below the vehicle to be lifted.

Different embodiments of the lift 1 cannot however be ruled out wherein there is, e.g., only one post 2 on which slides vertically just one sustaining element 4 made up of a frame for supporting the vehicle.

The lift 1 also comprises:
a fluid operating actuator device 7 associated with the trolleys 5;
a pumping device 8 associated with the actuator device 7 through a first closed circuit 9 suitable for pumping a first fluid towards the actuator device 7 to move the trolleys 5, and therefore the arms 4, from a lowered position to a raised position;
an exhaust valve 10 associated with the first circuit 9 and which can be operated to allow the outflow of the first fluid from the actuator device 7, so as to move the trolleys 5 from the raised position to the lowered position.

In particular, with reference not only to the embodiment of the lift 1 shown in the illustrations, the above first fluid used is a liquid, preferably oil, and the first circuit 9 is a hydraulic circuit linking together the actuator device 7, made up of a pair of hydraulic cylinders housed inside the posts 2 and associated with the trolleys 5, and the pumping device 8, composed of an electric motor 11 and of a hydraulic pump 12.

Each hydraulic cylinder 7 is associated with the respective trolley 5 by means of a mobile pulley system complete with:
a pulley 13 fastened to the free extremity of the rod of the hydraulic cylinder 7;
a chain 14 engaged inside the pulley 13 and having an anchoring extremity 15 fastened to the base 3 of the column 2 and an opposite extremity not shown in the illustrations, fastened to an internal portion of the trolley 5.

The lift 1 also comprises an oil sump 16 connected to the first circuit 9, upstream of the hydraulic pump 12.

A check valve 17 is connected downstream of the hydraulic pump 12 and allows the oil to flow only towards the hydraulic cylinders 7.

A maximum pressure valve 18, associated downstream of the hydraulic pump and connected to the sump 16, regulates the maximum pressure inside the first circuit 9 and limits the pressure peaks produced during the movement of the hydraulic cylinders 7.

The exhaust valve 10 is associated with a branch of the first circuit 9, between the check valve 17 and the hydraulic cylinders 7, and is connected to the sump 16. The opening of the exhaust valve 10 therefore allows the draining of the oil contained inside the hydraulic cylinders 7 towards the sump 16.

A limiting valve 19 is placed in between the exhaust valve 10 and the sump 16 and is suitable for limiting the flow of oil drained inside the sump 16.

Usefully, at least one safety valve 20 can be associated with at least one of the hydraulic cylinders 7, for the purpose of stopping the free downflow of the oil in case of breakage of the first circuit 9.

Advantageously, as shown in FIG. 7, the lift 1 comprises a second closed circuit 21, connected to the exhaust valve 10, and a manual device 22 for varying the pressure of a second fluid inside the second circuit between a minimum pressure value, when the exhaust valve 10 is closed, and a maximum pressure value, when the exhaust valve 10 is open.

In particular, with reference not only to the embodiment of the lift 1 shown in the illustrations, the above second fluid used is air and the second circuit 21 is a pneumatic circuit connecting together the exhaust valve 10, made up of a pneumatically operating valve, and the manual device 22.

The manual device 22 comprises a piston 23 of the pneumatic type, having an inner chamber 24 connected to the second circuit 21 and a plunger 25 sliding sealed inside the chamber 24 between a first extreme position and a second extreme position.

The manual device 22 also comprises a manual control 26 operatively associated with the plunger 25 and suited to move the plunger itself between the first and the second extreme position to vary the pressure of the air inside the second circuit 21, between the above minimum and maximum values respectively.

In particular, the manual control 26 is composed of a lever with an extremity associated revolvable around a side wall of one of the posts 2 and an opposite grip extremity. The piston 23 has a rod 27 with an extremity associated integral with the plunger 25 and an opposite extremity outside the chamber 24 and hinged in correspondence to a substantially intermediate section of the lever 26. Usefully, the manual device 22 comprises an elastic return element 28 for returning the plunger 25, of the type of a spring or the like, which operate to return the plunger 25 from the second extreme position towards the first extreme position.

In particular, the elastic element 28 can be made up, e.g., of one or more springs associated to the lever 26 or arranged inside the chamber 24.

In normal conditions, in the case of no outside force being exercised on the lever 26, the plunger 25 is kept by the elastic element 28 in the first extreme position and, therefore, inside the second circuit 21 the pressure of the air is equal to the minimum pressure value.

Advantageously, the lift 1 comprises a retention arrangement for retaining the trolleys 5 on the posts 2, altogether indicated by the reference 29 and suitable for intervening during the stop phase to prevent the accidental dropping of the arms 4 due, e.g., to a fault in the first circuit 9.

With particular but not sole reference to the embodiment of the lift 1 shown in the FIGS. 5 and 6, the retention arrangement 29 comprises:
a plurality of seats 30 made in succession on two uprights 31 arranged inside each of the posts 2;
a pair of fastening devices 32, of the type of pawls or the like, associated integral with each of the trolleys 5 and revolvable between a stop configuration (FIG. 5), wherein they are engaged inside the seats 30 to retain the trolleys 5 on the posts 2, and a release configuration (FIG. 6), wherein they are disengaged from the seats 30 to allow the trolleys 5 to drop onto the posts 2.

The retention arrangement 29 can comprises, furthermore, elastic thrust means for the fastening devices 32, not shown in the illustrations and composed, e.g., of one or more springs or the like, which operate to bring the fastening devices 32 from the release configuration to the stop configuration.

In particular, each of the fastening devices 32 has a tooth 32a which, in the stop configuration and during the downward movement of the trolleys 5, is suitable for engaging inside one of the seats 30.

Usefully, each of the fastening devices 32 has a curved portion 32b made above the tooth 32a which, in the stop configuration and during the elevation of the trolleys 5, is suitable for engaging against the surface of the upright 31 to disengage the tooth 32a from the seat 30. Consequently, during the elevation of the trolleys 5, the fastening devices 32 do not have to be brought to the release configuration.

The lift 1 comprises a fluid operating supplementary actuator device 33, associated with the fastening devices 32 and suited to move said fastening devices between the stop configuration and the release configuration.

Advantageously, the supplementary actuator device 33 is made up of a pair of pneumatic cylinders associated with respective fastening devices 32 and connected to the second circuit 21.

This way, the variation in the pressure of the air inside the second circuit 21 from the minimum value to the maximum value, done by means of the manual device 22, results in the operation of the pneumatic cylinders 33 which move the fastening devices 32 from the stop configuration to the release configuration.

The retention arrangement 29 also comprises drive apparatus for driving the movement produced by each of the pneumatic cylinders 33 to the fastening devices 32.

In particular, inside each post 2, these drive apparatus comprises a belt 34 or the like, which extends vertically and which has an upper extremity anchored to a fixed portion of the post 2 and a lower extremity fastened to a plate 35 with a substantially L shape and anchored turning to the base 3.

On each post 2, the pneumatic cylinder 33 is positioned in correspondence to the base 3 and, once operated, the rod of the pneumatic cylinder 33 is suitable for engaging on a surface of the plate 35, so as to slope the plate itself and exercise a downward traction on the belt 34 (FIG. 6).

A first pulley 36 is associated integral with the fastening device 32, while a second and a third pulley 37 and 38 are integrally associated with the trolley 5 on top and underneath the first pulley 36. The belt 34 is suitably positioned among the three pulleys 36, 37 and 38.

By means of the operation of the pneumatic cylinder 33, a traction is exercised on the belt 34 which stretches and engages on the first pulley 36, bringing the fastening device 32 from the stop configuration (FIG. 5) to the release configuration (FIG. 6).

Alternative embodiments of the above drive apparatus cannot however be ruled out.

Usefully, the lift 1 comprises at least a sensor device 39 suitable for detecting the correct positioning of the trolleys 5 along the posts 2 and, consequently, suitable for also detecting the presence of an obstacle along the trajectory of the arms 4 during the downward movement of the trolleys 5.

A safety device 40 is connected to the sensor device 39 and can be operated to vary air pressure inside the second circuit 21 from the maximum pressure value to the minimum pressure value.

This way, in the event of an obstacle being detected by the sensor device 39, the hydraulic cylinders 7 are stopped and the fastening devices 32 are returned to stop configuration.

With reference to the particular embodiment shown in the illustrations, the lift 1 comprises a safety device 40 for each of the posts 2, made up of a safety valve that can be operated to allow all the air to escape from the second circuit 21.

The lift 1 comprises a block 41 for fastening the anchoring extremity 15 of the chain 14, and a traction elastic element 42 of the anchoring extremity 15 towards the block 41, made up of a spring or the like.

The sensor device 39 is made up of a′ force transducer placed in between the anchoring extremity 15 and the block 41.

Usefully, the second circuit 21 has an inlet branch 43 with a connector 44 and a check valve 45. This inlet branch 43 can be used after the opening of one of the safety valves 40, to introduce air so as to restore normal operating pressure inside the second circuit 21.

The operation of the lift 1 according to the invention is as follows.

In normal conditions, the lever 26 is released and, consequently, the exhaust valve 10 is closed and the fastening devices 32 are in stop configuration.

After the positioning of a vehicle between the two posts 2 and the positioning of the pads 6 of the arms 4 in correspondence to the suitable dedicated areas below the vehicle, the electric motor 11 is operated by an operator and the hydraulic pump 12 pumps oil through the first circuit 9 towards the hydraulic cylinders 7. The hydraulic cylinders 7 lift the trolleys 5 and, consequently, the arms 4 lift the vehicle up to the required height.

Once the required maintenance or repair jobs have been performed, the operator effects the downward movement of the vehicle.

By means of the lever 26, the operator changes the pressure of the air inside the second circuit 21 from the minimum value to the maximum value.

Such pressure change causes the pneumatic cylinders 33 to operate and these move the fastening devices 32 from the stop configuration to the release configuration.

Furthermore, the change in air pressure inside the second circuit 21 from the minimum value to the maximum value results in the opening of the exhaust valve 10 which allows the oil to come out of the hydraulic cylinders 7 towards the sump 16 and, therefore, the lowering of the trolleys 5.

The vehicle is thus repositioned on the ground and can be moved off the lift 1.

In the event, during the downward movement, of one of the arms 4 encountering an obstacle, the respective hydraulic cylinder 7 continues to retract the rod, lowering the pulley 13.

This results in a drop in tension on the chain 14 and, consequently, a greater force exercised by the anchoring extremity 15 on the force transducer 39 due to the operation of the elastic element 28.

The force transducer 39, once this increased force has been detected, commands the opening of the respective safety valve 40 and, consequently, the pressure of the air inside the second circuit 21 is returned to minimum value.

This way, the exhaust valve 10 closes, stopping the downward movement of the trolleys 5, and the fastening devices 32 are returned to the stop configuration.

It has in fact been ascertained how the described invention achieves the proposed objects.

In particular, the fact is underlined that the presence of the manual drop device and of the closed pneumatic circuit for connection to the exhaust valve permits lowering the vehicles within the ambit of a solution that is easy to achieve, easy and effective to use and inexpensive.

In fact, the lift according to the invention permits effectively lowering the vehicles without using complicated control electronics and without using an external pneumatic supply line.

The presence of the fastening devices controlled by means of the manual device and their operation by means of the safety valves also allows complying with the safety requirements needed to ensure operator safety.

1) Post lift (1) for vehicles, comprising:
at least one supporting post (2);
at least one sustaining element (4) associated with said post (2), sliding along a substantially vertical direction and positionable in contact with at least a portion of a vehicle to be lifted;
at least a fluid operating actuator device (7) associated with said sustaining element (4);
at least a pumping device (8) associated with said actuator device (7) through a first closed circuit (9) and suitable for pumping a first fluid towards said actuator device (7) to move said sustaining element (4) from a lowered position to a raised position;
at least an exhaust valve (10) associated with said first circuit (9) and which can be operated to allow said first fluid to flow from said actuator device (7) to move said sustaining element (4) from said raised position to said lowered position;
at least a second closed circuit (21) associated with said exhaust valve (10); and
at least a manual device (22) for varying the pressure of a second fluid inside said second circuit (21) between a minimum pressure value, in which said exhaust valve (10) is closed, and a maximum pressure value, in which said exhaust valve (10) is open.

2) Lift (1) according to the claim 1, wherein said manual device (22) comprises:
at least a piston (23) having an inner chamber (24) associated with said second circuit (21) and a plunger (25) sliding sealed inside said chamber (24) between a first extreme position and a second extreme position;
at least a manual control (26) operatively associated with said plunger (25) and suitable for moving said plunger (25) between said first and second extreme position to vary the pressure of said second fluid between said minimum and maximum values.

3) Lift (1) according to the claim 2, wherein said manual device (22) comprises at leas an elastic return element (28) of said plunger (25) which operate to return said plunger (25) from said second extreme position to said first extreme position.

4) Lift (1) according to the claim 2, wherein said manual control (26) comprises at least a grip lever (26) associated with said plunger (25).

5) Lift (1) according to the claim 4, wherein said lever (26) comprises an extremity associated revolving with said post (2) and an opposite grip extremity, said piston (23) having a rod (27) with an extremity associated integral with said plunger (25) and an opposite extremity external to said chamber (24) and associated with said lever (26).

6) Lift (1) according to the claim 1, comprising:
a retention arrangement (29) of said sustaining element (4) on said post (2);
at least a fluid operating supplementary actuator device (33) associated with said retention arrangement (29) and suitable for moving said retention arrangement (29) between a stop configuration of said sustaining element (4) and a release configuration of said sustaining element (4);
in which said supplementary actuator device (33) are associated with said second circuit (21) and said manual device (22) is suitable for varying the pressure of said second fluid inside said second circuit (21) between said minimum and maximum pressure values to move said retention arrangement (29) between said stop and release configurations.

7) Lift (1) according to the claim 6, wherein said retention arrangement (29) comprises at least a seat (30) obtained on said post (2) and at least a fastening device (32) associated mobile with said sustaining element (4), said fastening device (32) being suitable for engaging inside said seat (30) in said stop configuration and for disengaging from said seat (30) in said release configuration.

8) Lift (1) according to the claim 7, wherein said retention arrangement (29) comprises elastic thrust means of said fastening device (32) which operate to bring said fastening device (32) from said release configuration to said stop configuration.

9) Lift (1) according to the claim 6, wherein said supplementary actuator device (33) comprises at least a fluid operating cylinder.

10) Lift (1) according to the claim 7, wherein said retention arrangement (29) comprises a drive apparatus (34, 35, 36, 37, 38) for driving the movement of said supplementary actuator device (33) to said fastening device (32).

11) Lift (1) according to the claim 10, wherein said drive apparatus (34, 35, 36, 37, 38) comprises:
at least a driving belt (34) or the like which extends along said post (2) and which has an extremity associated with said supplementary actuator device (33);
at least a pulley (36) or the like associated integral with said fastening device (32), said belt (34) being suitable for engaging on said pulley (36) to bring said fastening device (32) from said stop configuration to said release configuration.

12) Lift (1) according to the claim 1, comprising at least a sensor device (39) for detecting the correct positioning of said sustaining element (4) during downward sliding, said second circuit (21) having at least a safety device (40) associated with said sensor device (39) and which can be operated to vary the pressure of said second fluid from said maximum value to said minimum value.

13) Lift (1) according to the claim 12, wherein said safety device (40) comprises at least a safety valve (40) which can be operated to allow said second fluid to flow from said second circuit (21).

14) Lift (1) according to claim 1, wherein said first fluid is a liquid, said actuator device (7) is hydraulically operated, said first circuit (9) is composed of a hydraulic circuit and said pumping device (8) comprises at least a hydraulic pump.

15) Lift (1) according to claim 2, wherein said second fluid is a gas, said exhaust valve (10) is made up of a pneumatically operated valve, said second circuit (21) is composed of a pneumatic circuit, said supplementary actuator device (22) is pneumatically operated and said piston (23) is composed of a pneumatic piston.

16) Lift (1) according to the claim 1, comprising at least a sump (16) associated with said first circuit (9) and suitable for containing said first fluid, said exhaust valve (10) being associated with said sump (16).

17) Lift (1) according to the claim 1, comprising at least a trolley (5) associated with one of said posts (2), sliding along a substantially vertical direction and suitable for supporting at least one of said sustaining elements (4).

18) Lift (1) according to the claim 1, wherein at least one of said sustaining elements (4) comprises at least a substantially horizontal arm (2), of adjustable length and associated with said trolley (5) revolving around a substantially vertical axis.
